(19) United States
(12) Patent Application Publication
(10) Pub. No.: US 2025/0241811 A1
(43) Pub. Date: Jul. 31, 2025

(54) SELF-EXPANDING HEEL PROTECTOR

(71) Applicant: EHOB, Inc., Indianapolis, IN (US)

(72) Inventors: Christian Gastaldo, Indianapolis, IN (US); Brian Conway, Carmel, IN (US); Gregory R. Konkle, Indianapolis, IN (US); Scott Rogers, Carmel, IN (US)

(21) Appl. No.: 19/037,244

(22) Filed: Jan. 26, 2025

Related U.S. Application Data
(60) Provisional application No. 63/625,411, filed on Jan. 26, 2024.

(51) Int. Cl. A61G 7/057; A61G 7/075

(52) U.S. Cl. CPC A61G 7/057; A61G 7/0755

(57) ABSTRACT

A heel protector for reducing the force amplifications upon the foot when the body is in the supine position, includes a pair of main chambers defining a foot cavity therebetween configured to receive at least the ankle and foot of a patient and defining a leg opening for access to the foot cavity. The main chambers include a self-expanding core that adopts an expanded shape to define the foot cavity and that is compressible to a compressed shape for storage.

### PRIORITY CLAIM

This application claims priority to co-pending U.S. provisional application No. 63/625,411, filed on Jan. 26, 2024, the entire disclosure of which is incorporated herein by reference.

### BACKGROUND

In the supine position, the foot assumes the shape of a wedge that tapers from the toes down to the heel. The mechanical force amplifications that are typically associated with a wedge are therefore also experienced by the wedge-shaped foot. The heel area, and more specifically the points of contact between the heel area and the patient support surface or substrate upon which the body is lying in the supine position, experiences mechanical force amplifications that are analogous to those experienced by the working edge of the typical wedge. In addition, when in the supine position, the lower legs function as levers with the heel areas serving as fulcrums, further amplifying the mechanical forces acting upon the heel areas.

It has long been recognized that heel ulcers are caused by such mechanical forces (pressure, shear and frictional stresses) on the heel. Consequently, a heel protector that offloads the mechanical forces on the heel is an ideal way to prevent a pressure ulcer of the heel from developing. One such heel protector is a three-chambered inflatable foot cushion disclosed in U.S. Pat. No. 5,328,445, the entire disclosure of which is incorporated herein by reference. Foot cushions embodying this patent have provided exceptional prevention and treatment of pressure ulcers of the heel and other types of foot wounds. FIG. 1 shows a heel protector or foot cushion 10 that incorporates features from this original patent, as well as from later improvements in U.S. Pat. Nos. 9,301,866 and 10,350,102. The heel protector 10 includes a foot resting cavity 11 that is formed by two main inflatable chambers 12, 13 configured to wrap partially around the lower leg and foot, held in position by straps 14 and by a reclosable foot gate 15. The two chambers 12, 13 define a leg opening along the length of the heel protector, so that the patient's leg can be installed between the chambers and then held in place by the straps 14. The foot resting cavity offloads the mechanical forces on the heel, and provides symmetrical static air support to the calf, ankle and foot. The foot gate 15 includes two engageable panels that support the sole of the foot to prevent foot drop and resultant injury when the panels are overlapping and connected, as shown in FIG. 2. A third inflatable chamber 16 is an independent chamber affixed beneath the two main chambers as an accessory chamber to elevate the inflatable foot cushion and the patient's leg contained therein.

In another feature, the heel protector can be formed with several tubing ports 17. The ports provide access points for tubing connected to external devices, such as for wound suction or for sequential compression devices. The ports 17 also provide some ventilation for heat and moisture dissipation.

### SUMMARY OF THE DISCLOSURE

A heel protector is provided to reduce the force amplifications upon the foot when the body is in the supine position. The heel protector includes, among other components, a pair of main chambers that define a foot cavity therebetween configured to receive at least the ankle and foot of a patient. The main chambers are further configured to define a leg opening for access to the foot cavity to place the patient's leg within the cavity. At least one strap extends across the leg opening to connect the pair of main chambers over the leg of the patient to hold the patient's leg snugly within the heel protector. A foot gate may be provided to support the foot.

In one feature of the present disclosure, the pair of main chambers include a self-expanding core that adopts an expanded shape to define the foot cavity and that is compressible to a compressed shape for storage. The core can be formed of an open-cell foam with a plurality of interconnected interstices that can fill with air, causing the core to expand. The core is initially compressed by removing all of the air from the interstices. When the compressed core is released, air flows into the interstices until the core expands to its final configuration as a heel protector.

### DESCRIPTION OF THE DRAWINGS

FIG. 1 is a side view of a conventional heel protector.

FIG. 2 is a side view of a modified heel protector of the present disclosure.

FIG. 3 is perspective view of a self-expanding heel protector of the present disclosure shown in a compressed or un-expanded state.

FIG. 4 is a perspective view of the self-expanding heel protector of FIG. 3, shown in an intermediate or partially expanded state.

FIG. 5 is a side perspective view of the self-expanding heel protector of FIG. 3, shown in an expanded state.

FIG. 6 is an end perspective view of the self-expanding heel protector in the expanded state shown in FIG. 5.

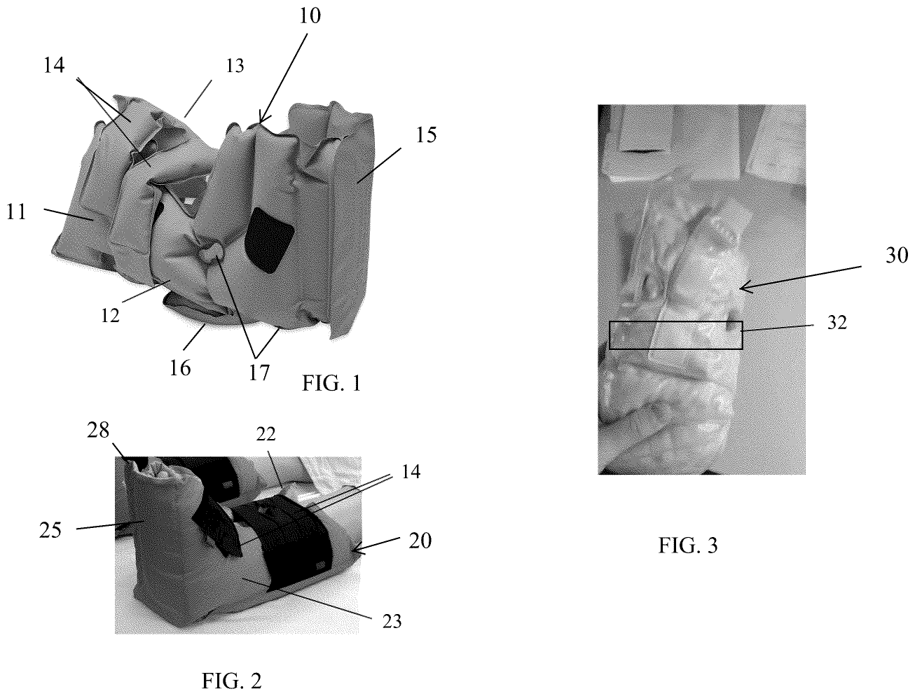

### DETAILED DESCRIPTION

The heel protector 20 of the present disclosure represents a further improvement to the prior foot cushions. The heel protector 20 is similar in construction to the heel protector 10 to define a similar foot cavity that receives the lower leg, ankle and foot of the patient, as shown in FIG. 2. Thus, the heel protector 20 includes the two main chambers 22, 23 that form the leg opening to receive the patient's lower leg, as well as the straps 14 for closing the patient's foot within the heel protector. The foot gate 25 is similar to the foot gate 15, but modified to includes an extension 28 at the end of the gate that encases the toes of the patient. This extension 28 thus provides protection to the toes.

Some prior foot cushions incorporated inflatable bladders that require an air pump to inflate. While it is advantageous that the cushion can be deflated for easy storage, additional components in the form of a pump and tubing are required with the inflatable foot cushion. The heel protector of the present disclosure incorporates a self-expanding core 30, as shown in FIGS. 3-6. In one embodiment, the core is formed of an open-cell polyurethane (PU) polymer coated with flock. The PU is formed as a foam with interconnected interstices that can fill with air, causing the core to expand. When the core 30 is fully expanded, it retains its configuration and is able to bear the weight of the patient's lower leg and perform the function of a heel protector. Other polymer foams are contemplated provided that the material can maintain its configuration upon expansion and serve as a hell protector.

As shown in FIG. 3, the core 30 can be compressed into a small package by squeezing the core to expel all of the air within the core. The compressed core can be held compressed by packaging completely or substantially encasing the core. Alternatively, the core can be held compressed by a removable strap 32 or multiple such straps. The straps can be configured to assist in compressing the core 30. The strap(s) can be formed of an elastic material or can be formed of an inextensible material with a releasable fastener arrangement, such as a hook and loop fastener.

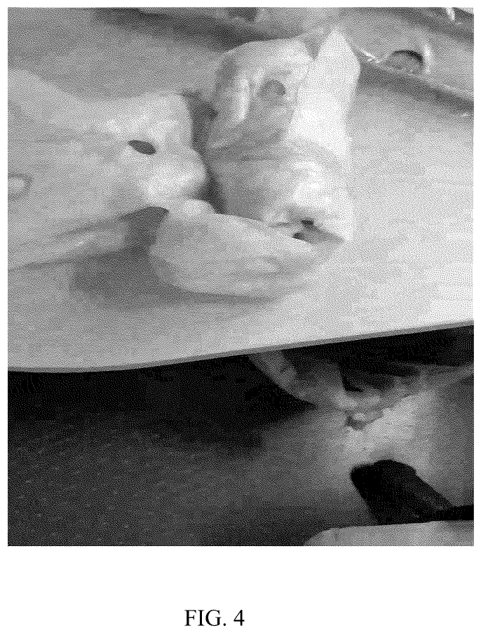

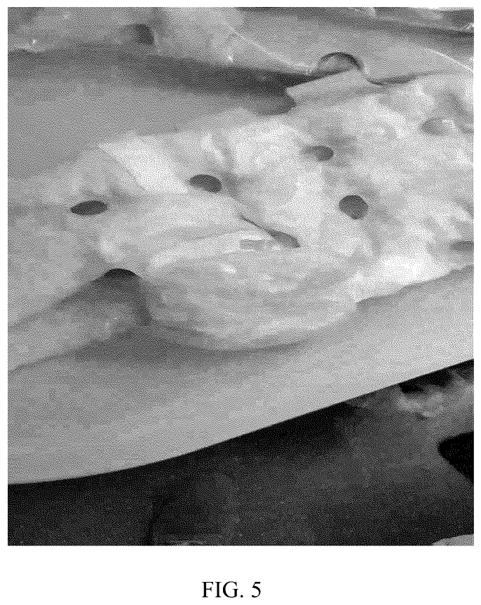

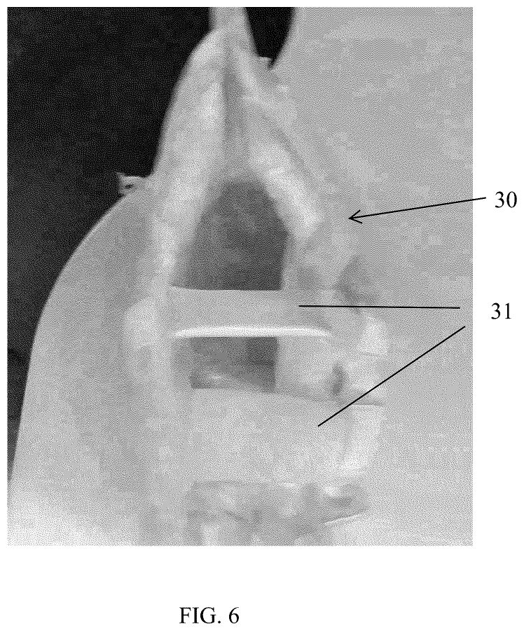

Once the core is removed from the packaging or the removable strap 32 is released, the core automatically starts to unfold as air feeds into the interstices, as shown in FIG. 4. As the core unfolds, the movement of the core tends to suck air into the interstices until the core is fully expanded, as shown in FIGS. 5-6. It is appreciated that the core can be covered in the manner shown in FIG. 2 with a fabric or polymer material, such as a closed-cell PVC or a polyurethane film. In some embodiments, the core 30 can include a pair of straps 31 spanning the heel protector opening to restrain the expansion of the core and allow it to be better fitted onto a patient's foot and lower leg.

A single core can be provided that embodies the full final shape of the foot protector 20 shown in FIG. 2. Alternatively, a separate core may be provided in each of the main chambers 22, 23. In addition, the foot gate 25 may be provided with its own self-expanding core.

In some embodiments, the core can be provided with one or more air inlets that can be initially closed to keep the core in its compressed state, even without the packaging or removable strap. When the core is to be expanded, the valves can be manually opened so that air can be drawn freely into the interstices of the core. The valves can be strategically placed on the heel protector 20 to decrease the amount of time required for the core to fully expand.

This device has enhanced features that provide unique benefits. The extended foot gate ensures the toes are encapsulated within the boot and are not exposed to the open air or other devices that may cause damage to the toes. The use of an open celled foam on the inside of the boot allows for the boot to be rolled up and stored in a small form, but then self-inflate into the correct shape. This self-inflating feature of the heel protector allows for a custom inflation per patient, and saves storage space inside the hospital, without taking too much of a nurse's time to inflate a conventional heel protector with a hand-pump.

What is claimed is:

1. A heel protector to reduce the force amplifications upon the foot when the body is in the supine position, comprising:
a pair of main chambers defining a foot cavity therebetween configured to receive at least the ankle and foot of a patient and defining a leg opening for access to the foot cavity; and
at least one strap extending across the leg opening to connect the pair of main chambers over the leg of the patient,
wherein the pair of main chambers includes a self-expanding core that adopts an expanded shape to define the foot cavity and that is compressible to a compressed shape for storage.

2. The heel protector of claim 1, wherein the core is open-cell polyurethane (PU) polymer coated with flock, with a plurality of interconnected interstices for receiving air.

3. The heel protector of claim 1, wherein each of the pair of main chambers includes separate self-expanding cores.

4. The heel protector of claim 1, further comprising a foot gate.

5. The heel protector of claim 4, wherein the foot gate includes a self-expanding core separate from the self-expanding core of the pair of main chambers.
